(19) United States
(12) Patent Application Publication
(10) Pub. No.: US 2018/0317045 A1
(43) Pub. Date: Nov. 1, 2018

(54) POSITIONING DEVICE USING CROWD-SOURCED CELLULAR DATA

(71) Applicant: QUALCOMM Incorporated, San Diego, CA (US)

(72) Inventors: Jordan Cookman, San Jose, CA (US); Jie Wu, San Diego, CA (US); Brian Banister, San Diego, CA (US); Yongle Wu, San Diego, CA (US)

(21) Appl. No.: 15/582,492

(22) Filed: Apr. 28, 2017

(51) Int. Cl. H04W 4/02; G01S 5/02; G01S 5/10

(52) U.S. Cl. CPC H04W 4/023; G01S 5/10; G01S 5/0236

(57) ABSTRACT

The disclosure generally relates to positioning techniques that can be used in a wireless communications network. For example, assistance data that includes predicted contents associated with messages that multiple neighboring nodes are configured to transmit at a synchronized time may be encoded and correlated with a signal received at one or more receive antennas on a user device. The correlation may be used to estimate a channel response from one or more transmit antennas at a current node that transmitted the signal to the one or more receive antennas on the user device, whereby an estimated time of arrival from the current node can be computed based at least in part on the estimated channel response.

### TECHNICAL FIELD

The various aspects and embodiments described herein generally relate to positioning techniques that can be used in a wireless communications network.

### BACKGROUND

Mobile communications networks continue to offer increasingly sophisticated capabilities to sense the motion and/or position location associated with a mobile device. New software applications, such as, for example, those related to personal productivity, collaborative communications, social networking, data acquisition, and others may utilize motion and/or position sensors to provide new features and services to consumers. Moreover, some jurisdictions have regulatory requirements requiring that cellular network operators provide mechanisms to accurately locate user devices, for example, to report the location of a mobile device when a call is placed to an emergency service (e.g., a 911 call in the United States). Furthermore, a service that can be used to determine the position associated with a user device operating within a cellular communications network system may advantageously offer the ability to locate vehicles in a dispatching or fleet monitoring system, to customize service parameters based on an accurate knowledge relating to mobile user device locations, and to locate stolen mobile phones and investigate fraudulent use of cellular services, among other things.

In conventional digital cellular networks, position location capability can be provided through various time and/or phase measurement techniques. For example, in CDMA networks, one position determination approach used is Advanced Forward Link Trilateration (AFLT). Using AFLT, a mobile device may compute a position associated therewith based on phase measurements relating to reference signals (e.g., pilot signals) transmitted from various base stations or other network nodes. Theoretically-speaking, the exact location associated with each network node, the exact time at which the network node is transmitting, and the time of arrival (TOA) at the mobile device can be used to triangulate the position associated with the mobile device. Typically at least three range measurements to three different nodes are needed to calculate a position. In some cellular communications networks, there are certain reference signals specifically designed for ranging (e.g., Positioning Reference Signals (PRS) in LTE networks). However, transmitting the PRS is optional, whereby the reference signals that are designed for ranging are not available in all cellular communications networks. Although other reference signals that are designed for channel estimation can also be used for ranging (e.g., cell-specific reference signals (CRS) in LTE networks), these reference signals are often subject to inter-cell interference. As such, the inter-cell interference may cause difficulties with respect to obtaining three different measurements when the signal from one cell is dominant. The interference present in the reference signals from the weaker cell is generally unpredictable, making the interference difficult to estimate and cancel. Therefore, a method to support ranging (or positioning) in a cellular communications network that is both universal and more amenable to interference cancellation would be desirable.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, as will be described in further detail herein, a method for use in wireless signal-based positioning may comprise receiving, from a current node among multiple neighboring nodes in a wireless network, a signal at one or more receive antennas on a user device, encoding assistance data that includes predicted contents associated with messages that the multiple neighboring nodes are configured to transmit at a synchronized time to obtain the predicted contents associated with the message for the current node, correlating the predicted contents associated with the message for the current node with the received signal to estimate a channel response from one or more transmit antennas at the current node to the one or more receive antennas on the user device, and computing an estimated time of arrival from the current node based on the estimated channel response from one or more transmit antennas at the current node to the one or more receive antennas on the user device.

According to various aspects, an apparatus may comprise a transceiver comprising one or more receive antennas configured to receive a signal from a current node among multiple neighboring nodes in a wireless network and one or more processors configured to encode assistance data that includes predicted contents associated with messages that the multiple neighboring nodes are configured to transmit at a synchronized time to obtain the predicted contents associated with the message for the current node, correlate the predicted contents associated with the message for the current node with the received signal to estimate a channel response from one or more transmit antennas at the current node to the one or more receive antennas, and compute an estimated time of arrival from the current node based, at least in part, on the estimated channel response from one or more transmit antennas at the current node to the one or more receive antennas.

According to various aspects, an apparatus may comprise means for receiving a signal from a current node among multiple neighboring nodes in a wireless network, means for encoding assistance data that includes predicted contents associated with messages that the multiple neighboring nodes are configured to transmit at a synchronized time to obtain the predicted contents associated with the message for the current node, means for correlating the predicted contents associated with the message for the current node with the received signal to estimate a channel response from one or more transmit antennas at the current node to the means for receiving, and means for computing an estimated time of arrival from the current node based, at least in part, on the estimated channel response from one or more transmit antennas at the current node to the means for receiving.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary operating environment in which a mobile platform may determine a position associated therewith based on crowd-sourced data in a cellular communications network, according to various aspects.

FIG. 2A-2C illustrate exemplary cellular network environments in which crowd-sourced data may be used to enable a user device to determine a position associated therewith, according to various aspects.

FIG. 3 illustrates an exemplary user device that may determine a position based on crowd-sourced cellular data, according to various aspects.

FIG. 4 illustrates an exemplary method that can be used to crowd-source cellular data to enable position determination at a user device in a cellular communications network, according to various aspects.

FIG. 5 illustrates an exemplary method to determine a position at a user device based on crowd-sourced cellular data, according to various aspects.

FIG. 6 illustrates exemplary user devices that may determine a position using crowd-sourced cellular data, according to various aspects.

FIG. 7 illustrates an exemplary user device and an exemplary network node in a cellular communications network, according to various aspects.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the terms “user device,” “user equipment” (or “UE”), “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device that can communicate with a radio access network (RAN) that implements a particular radio access technology (RAT), over a wired network, over a Wi-Fi network (e.g., based on IEEE 802.11, etc.), etc.

The position determination techniques described herein may be used for various wireless communication networks such as a wireless wide area network (WWAN), a wireless local area network (WLAN), a wireless personal area network (WPAN), and so on. The term “network” and “system” may be used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more radio access technologies (RATs) such as CDMA2000, Wideband-CDMA (W-CDMA), and so on. CDMA2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). CDMA2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of a WWAN, WLAN and/or WPAN.

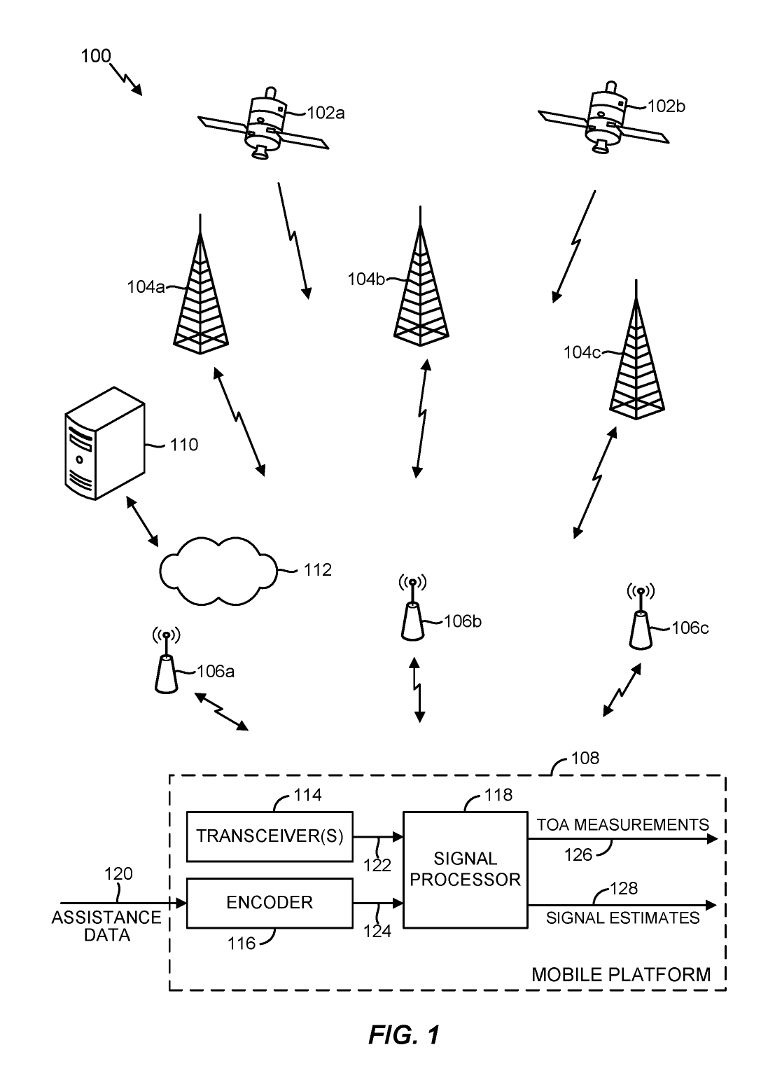

According to various aspects, FIG. 1 illustrates an exemplary operating environment 100 in which a user device may include a mobile platform 108 configured to determine a position associated with the user device based on crowd-sourced data in a cellular communications network. For example, as will be described in further detail herein, the cellular communications network may include various nodes 104a, 104b, 104c, etc., collectively referred to herein as “cellular network nodes” 104. In various embodiments, the cellular network nodes 104 may each be configured to broadcast or otherwise transmit a message at a synchronized time, wherein the message may be available to the mobile platform 108 and all other user devices operating in the cellular communications network. Each message may generally contain some basic information about a respective cellular network node 104a, 104b, 104c, etc. For example, in LTE networks, a physical broadcast channel (PBCH) may carry a Master Information Block (MIB), which may indicate various parameters that can be used to access a cell. The information that the cellular network nodes 104 transmit in the message typically does not change often, or tends to change in a predictable way. Accordingly, assuming that the time-synchronized message data for all cellular network nodes 104 in a given area are known and made available to the mobile platform 108, then the time-synchronized signals can be used in a similar way as reference signals to perform ranging operations.

Furthermore, although the time-synchronized messages that are transmitted from neighboring cellular network nodes 104 may potentially interfere with one another, the time-synchronized messages may not be subject to interference from other unpredictable signals. As a result, the interfering time-synchronized signals are easier to estimate and cancel, enabling ranging operations to be performed based thereon.

According to various aspects, the example operating environment 100 shown in

FIG. 1 may contain one or more different wireless communication systems and/or wireless positioning systems, which may include at least the cellular communications network in which the cellular network nodes 104 operate.

In the example embodiment shown in FIG. 1, one or more space vehicles (SV) (e.g., Satellite Positioning System (SPS) satellites 102a, 102b) may provide an independent source of position information for the mobile platform 108. In various embodiments, the mobile platform 108 may include one or more dedicated SPS receivers specifically designed to receive signals for deriving geo-location information from the SPS satellites 102a, 102b. In certain implementations, the SPS receiver may be configured to acquire and make use of SPS signals from various systems, separately or together. For example, the SPS receiver may acquire SPS signals from a global navigation satellite system (GNSS) such as the Global Positioning System (GPS), the Global Navigation Satellite System (GLONASS), Galileo, etc., or from one or more regional navigation systems such as BeiDou (China), the Indian Regional Navigation Satellite System (IRNSS), etc., or any suitable combination thereof.

According to various aspects, the operating environment 100 may also include the cellular network nodes 104, which may be used for wireless voice and/or data communication and provide another independent source of position information for the mobile platform 108. The cellular network nodes 104 may be part of a wireless wide area network (WWAN), which may include cellular base stations at known locations, and/or other wide area wireless systems (e.g., Worldwide Interoperability for Microwave Access (WiMAX) (e.g., IEEE 802.16)). The WWAN may include other known network components which are not shown in FIG. 1 for simplicity. Typically, the cellular network nodes 104 within the WWAN each operate from a fixed position and provide network coverage over a relatively large metropolitan and/or regional area. However, those skilled in the art will appreciate that the cellular network nodes 104 may in fact be moveable or otherwise able to be relocated from one location to another.

According to various embodiments, the cellular network nodes 104 may operate in a cellular communications network that may include, but is not limited to, standards in accordance with GSM, CMDA, 2G, 3G, 4G, LTE, etc.

According to various aspects, the operating environment 100 may also include one or more wireless access points (WAPs) 106a, 106b, 106c, which may be used for wireless voice and/or data communication and provide another independent source of position data. The WAPs 106 can be part of a wireless local area network (WLAN), which may operate in buildings and perform communications over smaller geographic regions than a WWAN. Such WAPs 106 may be part of, for example, Wi-Fi networks (802.11x), cellular piconets and/or femtocells, Bluetooth networks, etc.

The mobile platform 108 may derive position information from any one or more of the SPS satellites 102, the cellular network nodes 104, and/or the WAPs 106. The aforementioned systems can each provide information to make an independent estimate of the position for the mobile platform 108 using different techniques. In some embodiments, the mobile platform 108 may combine the solutions derived from different systems to improve the accuracy of the position estimate. The mobile platform 108 may determine the position associated therewith using time-of-arrival (TOA) techniques such as, for example, Advanced Forward Link Trilateration (AFLT). Furthermore, as will be described in further detail below, various aspects and embodiments contemplate that the mobile platform 108 may determine the position associated therewith using assistance data 120 that may be generated locally and/or received from a server 110 via a network 112, which may include one or more wired and/or wireless networks that incorporate the WAPs 106 and/or the cellular network nodes 104. More particularly, according to various aspects, the cellular network nodes 104 may each take the form of a base station or other suitable node within a cellular communications network. As will be described in further detail herein, the mobile platform 108 may include a cellular transceiver 114 configured to receive one or more messages from the cellular network nodes 104 at a synchronized time and signal processor 118 that can exploit the messages received from the cellular network nodes 104 in combination with the assistance data 120 to derive a position.

For example, in various embodiments, the assistance data 120 may comprise a database that includes the contents associated with time-synchronized messages that the cellular network nodes 104 are configured to transmit. Alternatively and/or additionally, the assistance data 120 may comprise a prediction about the contents associated with time-synchronized messages to be transmitted from the one or more cellular network nodes 104 at a particular point in time. In various embodiments, as mentioned above, the assistance data 120 may be received from the server 110, in which case the assistance data 120 may comprise the contents associated with the message(s) that each cellular network node 104 is configured to transmit at a synchronized time based on crowd-sourced messages from a user device population. Alternatively, the mobile platform 108 may build the assistance data 120 locally based on messages from cellular network nodes 104 with which the mobile platform 108 has communicated. In a further alternative, the mobile platform 108 may decode the time-synchronized message received from a serving cellular network node 104 and use the decoded message for various neighboring cellular network nodes 104 (e.g., based on an assumption that the assistance data 120 is the same for all neighboring cellular network nodes 104). In the latter case(s), the mobile platform 108 may operate independently from the server 110, although the number and/or accuracy of cellular network nodes 104 that can be measured may be reduced (especially in early stages of the device lifecycle when an internal database that includes the assistance data 120 is sparsely populated).

According to various aspects, whether received from the server 110, generated locally, or otherwise obtained, the mobile platform 108 may provide the assistance data 120 that indicates the message information predicted to be transmitted from multiple neighbor cellular network nodes 104 at a particular point in time to an encoder 116. The encoder 116 may be configured to encode the time-synchronized message information to obtain a local copy 124 corresponding to the signal that one cellular network node is configured to transmit (e.g., cellular network node 104a, 104b, 104c, etc.). The local copy 124 and an overall signal 122 received at the cellular transceiver 114 may be provided to a signal processor 118, which may be configured to generate a signal estimate 128 indicating a portion of the overall signal 122 attributable to the one cellular network node 104a, 104b, 104c, etc. Furthermore, the signal processor 118 may be configured to compute a time of arrival (TOA) measurement 126, a pseudorange 126, or other suitable ranging data based on the signal estimate 128 attributable to the one cellular network node 104a, 104b, 104c, etc. The mobile platform 108 may process the assistance data 120 and the overall signal 122 in substantially the same manner with respect to each cellular network node 104a, 104b, 104c, etc. with available message information at a particular time. The mobile platform 108 may thereby produce sufficient TOA measurements 126, pseudoranges 126, etc. to compute a position based on the signal estimates 128 associated with each cellular network node 104a, 104b, 104c, etc. for which the time-synchronized message information is available.

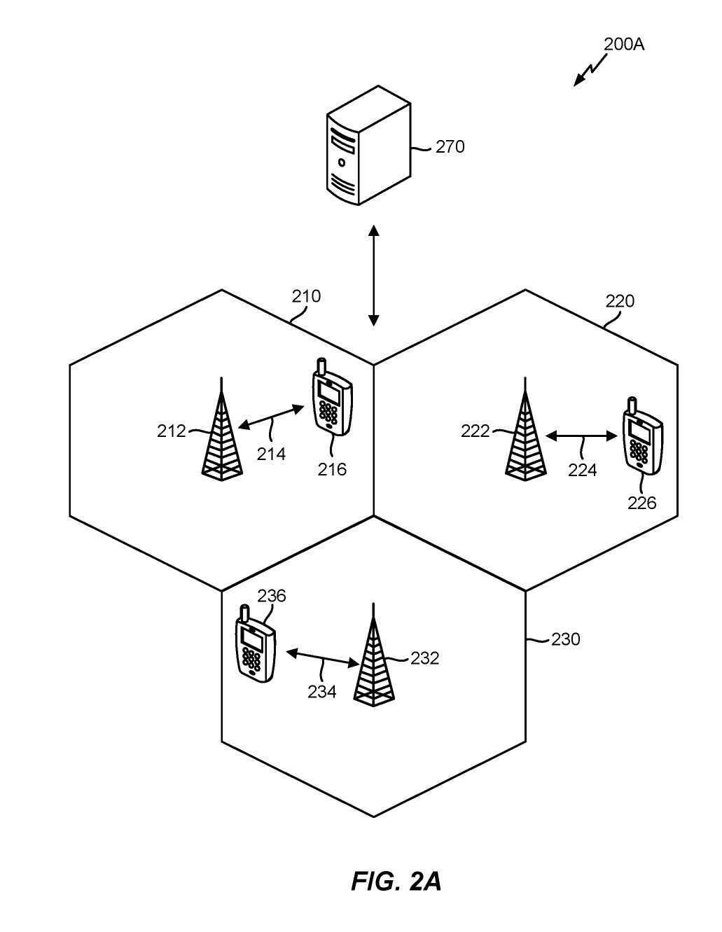

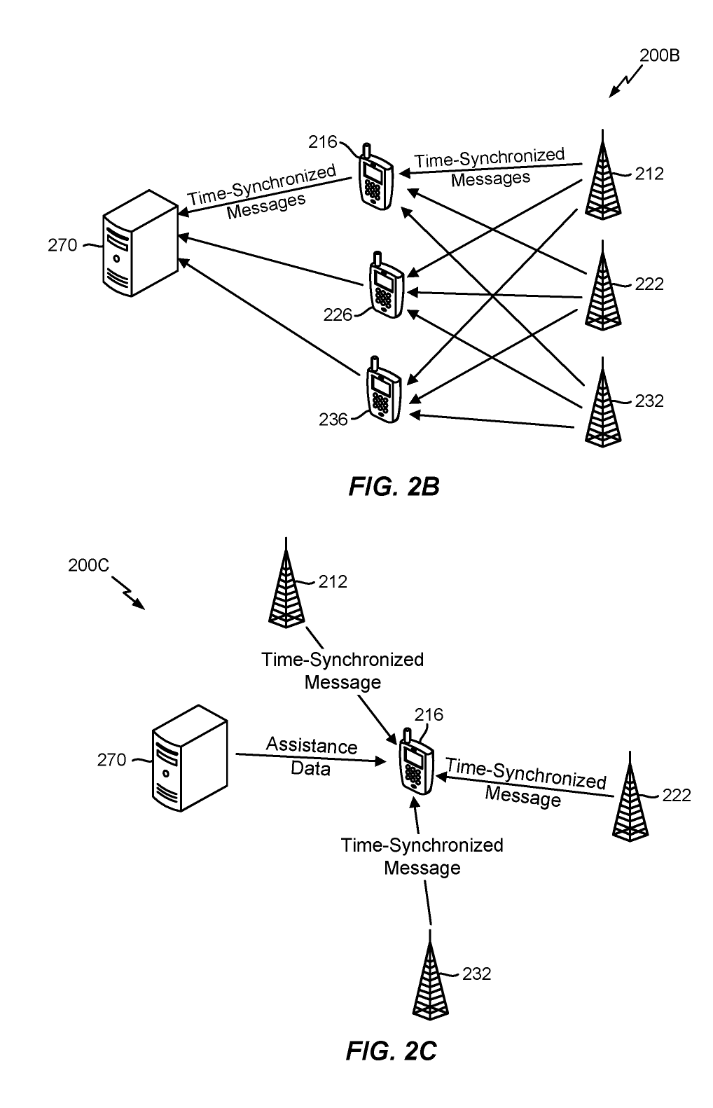

According to various aspects, exemplary cellular network environments in which crowd-sourced data may be used to enable a user device to determine a position associated therewith will now be described in further detail with reference to FIG. 2A-2C. More particularly, referring to FIG. 2A, the cellular network environment is illustrated as an access network 200A that includes a first cell 210 having a first base station 212, a second cell 220 having a second base station 222, and a third cell 230 having a third base station 232. In general, the coverage area associated with a given base station is represented via the respective cell in which the given base station is located, whereby in FIG. 2A, the first cell 210 includes the coverage area corresponding to the first base station 212, the second cell 220 includes the coverage area corresponding to the second base station 222, and the third cell 230 includes the coverage area corresponding to the third base station 232. The cells 210, 220, 230 in the access network 200A also include various user devices that communicate with the respective base stations 212, 222, 232 and an application server 270 that may communicate with the user devices via the respective base stations 212, 222, 232 or via a separate network (e.g., a WLAN network). For example, in FIG. 2A, the first cell 210 includes a first user device 216 in communication with the first base station 212 via a first link 214, the second cell 220 includes a second user device 226 in communication with the second base station 222 via a second link 224, and the third cell 230 includes a third user device 236 in communication with the third base station 232 via a third link 234. Although not shown in FIG. 2A, the base stations 212, 222, 232 may also be connected to one another via a backhaul link.

According to various aspects, the various base stations 212, 222, 232, etc. in the network 200A may each be configured to transmit a message at a synchronized time, wherein the message may be available to all user devices 216, 226, 236, etc. and contain some basic information about the transmitting base stations 212, 222, 232, etc. to enable the user devices 216, 226, 236, etc. to access the respective cells 210, 220, 230, etc. For example, in LTE networks, a physical broadcast channel (PBCH) may be used to convey a Master Information Block (MIB) that indicates various parameters used to access a cell 210, 220, 230, etc. The information conveyed in the time-synchronized message may change infrequently (if at all), and furthermore, may change in a predictable way if and/or when the information transmitted therein does change. Accordingly, the various aspects and embodiments described herein contemplate that the time-synchronized messages transmitted within the network 200A may be crowd-sourced and used to enable ranging operations at the user devices 216, 226, 236, etc.

For example, FIG. 2B illustrates an example crowd-sourcing arrangement 200B that may be used to build and maintain a message database (not explicitly shown) that includes the time-synchronized message data for each node in a cellular network. In the particular example shown in FIG. 2B, base stations 212, 222, and 232 are the only nodes illustrated and user devices 216, 226, 236 are the only user devices illustrated. However, those skilled in the art will appreciate that in practice there may be substantially more nodes and user devices operating in any given cellular network. In various embodiments, as mentioned above, the base stations 212, 222, 232 are each configured to transmit time-synchronized messages that convey information that the user devices 216, 226, 236 can use to access a cell in which the base stations 212, 222, 232 provide coverage. Furthermore, because coverage areas tend to at least partially overlap, an overall receive signal at each user device 216, 226, 236 may comprise portions that are attributable to the time-synchronized messages transmitted from neighboring base stations 212, 222, 232. For example, as shown in FIG. 2B, the message that the first base station 212 transmits is received at the first user device 216 located in the same cell as the first base station 212 as well as the user devices 226, 236 that are located in neighboring cells associated with base stations 222, 232. In addition, the same principle applies to the messages that the second and third base stations 222, 232 transmit, which are received at each user device 216, 226, 236 in FIG. 2B.

Accordingly, in the crowd-sourcing arrangement 200B in FIG. 2B, the application server 270 may “crowd-source” the contents associated with the time-synchronized messages transmitted from each node in the cellular network, which may involve each user device 216, 226, 236 decoding the message from a serving node and transmitting the decoded message information to the application server 270. For example, in the example arrangement 200B shown in FIG. 2B, the first user device 216 decodes and transmits the message from serving base station 212 to the application server, the second user device 226 decodes and transmits the message from serving base station 222 to the application server, and so on. As such, the application server 270 may build and/or maintain the message database that includes the time-synchronized message data for each node in the cellular network based on the messages that are crowd-sourced from the various user devices 216, 226, 236, etc. Furthermore, as mentioned above, one or more of the user devices 216, 226, 236, etc. may build an internal database based on the messages that are received from the cellular network nodes (if any) that the user devices 216, 226, 236, etc. have been in communication with (e.g., base stations 212, 222, 232 in the illustrated example). In this manner, the user devices 216, 226, 236, etc. may operate independently from the server 270. However, in use cases where the user devices 216, 226, 236, etc. rely on the internal database, the number of cellular network nodes that can be measured may be limited to those nodes with which the user devices 216, 226, 236, etc. have communicated with, which may be reduced relative to the number of nodes in the database built at the server 270.

According to various aspects, referring now to FIG. 2C, an exemplary assistance arrangement 200C is illustrated in which the message database based on the crowd-sourced time-synchronized messages is used to derive assistance data to assist user devices in determining positions associated therewith. For example, in the arrangement 200C shown in FIG. 2C, the user device 216 receives the assistance data from the application server 270, wherein the assistance data may comprise a prediction about the contents associated with the messages for neighboring base stations 212, 222, 232 at a particular point in time (e.g., in an LTE network, the prediction may be a system frame number for neighboring base stations 212, 222, 232 at the particular time). In one alternate example, the assistance data provided to the user device 216 may include the message database that is built and/or maintained at the application server 270, in which case the user device 216 may predict the contents associated with the time-synchronized messages for neighboring base stations 212, 222, 232 independently. In a further alternative, the application server 270 may predict the contents associated with the time-synchronized messages for neighboring base stations 212, 222, 232 and the assistance data may include both the database and the predicted contents. In any case, the assistance data received from the application server 270 may make the time-synchronized message data for neighboring base stations 212, 222, 232 in a given area known and available to the user device 216 such that the time-synchronized signals from the neighboring base stations 212, 222, 232 can be used in in a similar way as reference signals to perform ranging operations. Furthermore, although the time-synchronized messages transmitted from the neighboring base stations 212, 222, 232 may potentially interfere with one another, the time-synchronized messages may not be subject to interference from other unpredictable signals. As a result, the interfering time-synchronized signals are easier to estimate and cancel at the user device 216, thus enabling ranging operations based thereon.

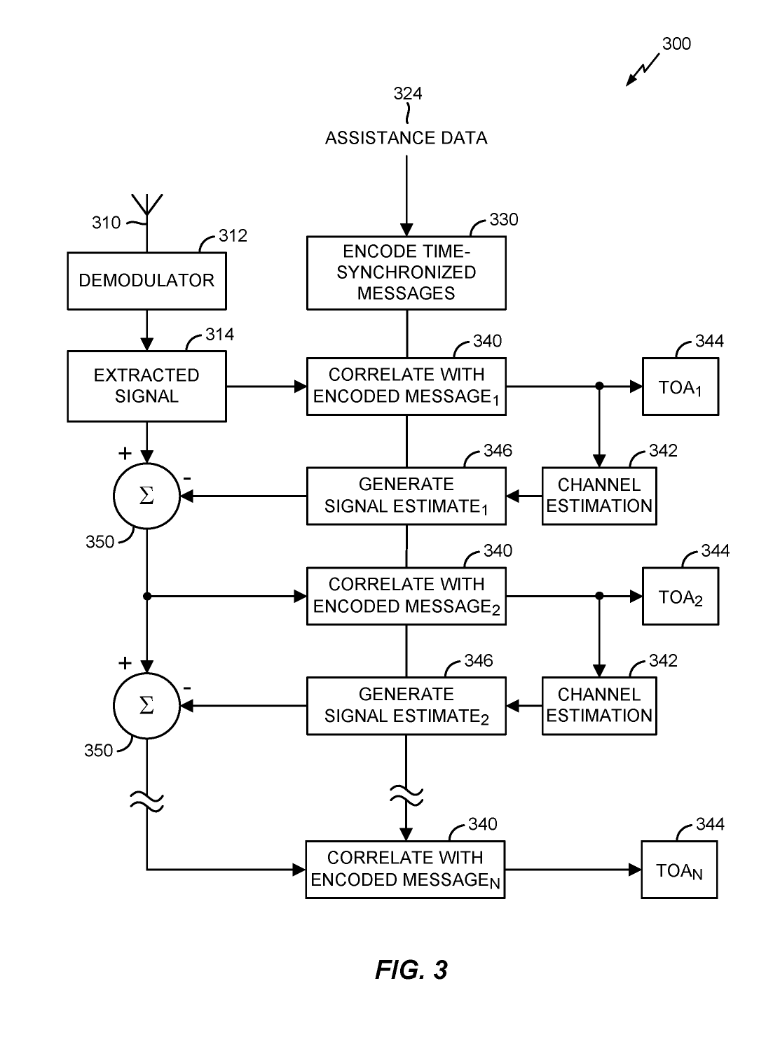

For example, according to various aspects, FIG. 3 illustrates an exemplary user device 300 that may determine a position based on cellular data that may be used to derive assistance data 324, which may be received from a server and/or generated locally as detailed above. In particular, the assistance data 324 may comprise a database based on time-synchronized messages that various nodes in a cellular network are configured to transmit to enable communication with user devices, a prediction about the contents associated with the messages that will be transmitted from multiple neighboring nodes at a particular point in time (e.g., a system frame number for each node), and/or any suitable combination thereof. In any case, the assistance data 324 may make the time-synchronized message data for multiple neighboring nodes available to the user device 300, which may encode the time-synchronized message data to obtain a local copy corresponding to the signal transmitted from one particular node, hereinafter termed the “current” node, as depicted at block 330. Furthermore, as shown in FIG. 3, the user device 300 may include one or more receive antennas 310 coupled to a front-end demodulator 312, which may extract a signal as depicted at block 314. In general, the extracted signal 314 may include portions that are attributable to time-synchronized messages transmitted from one or several neighboring nodes.

According to various embodiments, the extracted signal 314 may be correlated with the encoded message from the current node, as depicted at block 340. Channel estimation can then be performed, as depicted at block 342, to estimate a channel response from one or more transmit antennas at the current node to the one or more receive antennas 310 at the user device 300. As such, based on the estimated channel response from the one or more transmit antennas at the current node to the one or more receive antennas 310 at the user device 300, a pseudorange or time of arrival (TOA) estimate 344 with respect to the time-synchronized message from the current node can be computed from the estimated channel response. Furthermore, the estimated channel response can be used to estimate the signal received at the one or more receive antennas 310 that is due to the time-synchronized message from the current node, as depicted at block 346. The estimated signal due to the message from the current node can then be subtracted from the overall signal 314 received at the corresponding receive antenna(s) 310, as depicted at 350. The above-mentioned steps can then be repeated based on the remaining portion of the overall signal 314 with respect to each node with available message information, eventually yielding pseudoranges or TOA estimates 344 from a plurality of neighboring nodes. Assuming that three or more pseudoranges or TOA estimates 344 can be computed, the user device 300 can thereby determine a position.

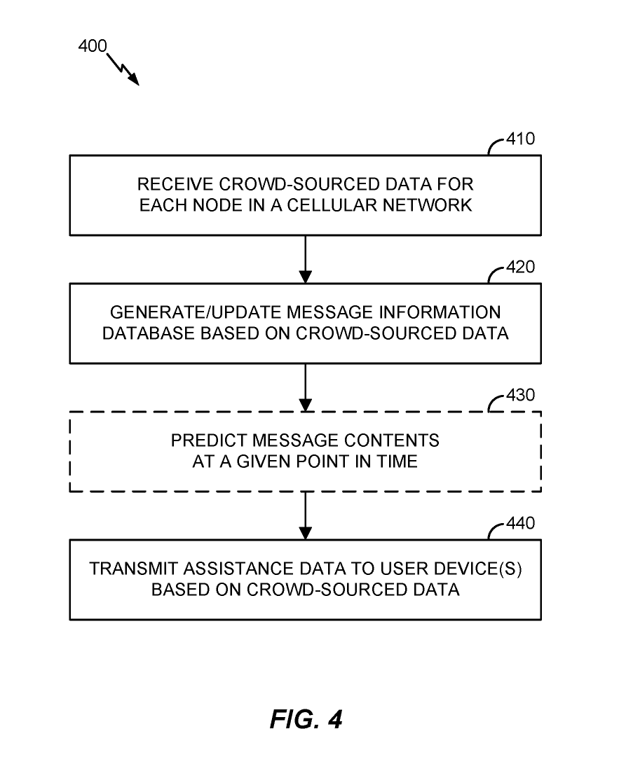

According to various aspects, FIG. 4 illustrates an exemplary method 400 that can be used to crowd-source cellular data to enable position determination at a user device in a cellular communications network. More particularly, the method 400 shown in FIG. 4 may generally be performed at a server, which may receive crowd-sourced data for each node in a cellular network at block 410. For example, a population of user devices deployed throughout the cellular network may receive time-synchronized messages from one or several network nodes and decode the time-synchronized message that was transmitted from a serving node. Each user device may then transmit the decoded message, which may be received at the server at block 410. The server may then generate and/or update a message information database based on the crowd-sourced messages at block 420 and optionally predict the contents associated with the time-synchronized messages for each node at a given point in time at block 430. For example, in an LTE network, the predicted contents may comprise a system frame number for each node at the given point in time. In various embodiments, at block 440, the server may then transmit assistance data based on the crowd-sourced messages to one or more user devices. For example, in various embodiments, the transmitted assistance data may comprise the most recent message information database, which may thus be stored locally on the user device(s). Alternatively and/or additionally, the assistance data may comprise the predicted contents associated with the time-synchronized messages that will be transmitted from multiple neighboring nodes in an area around the user devices. In any case, the user device(s) may then use the assistance data to determine a position based on time-synchronized messages that the user device(s) receive from various nodes in a surrounding area.

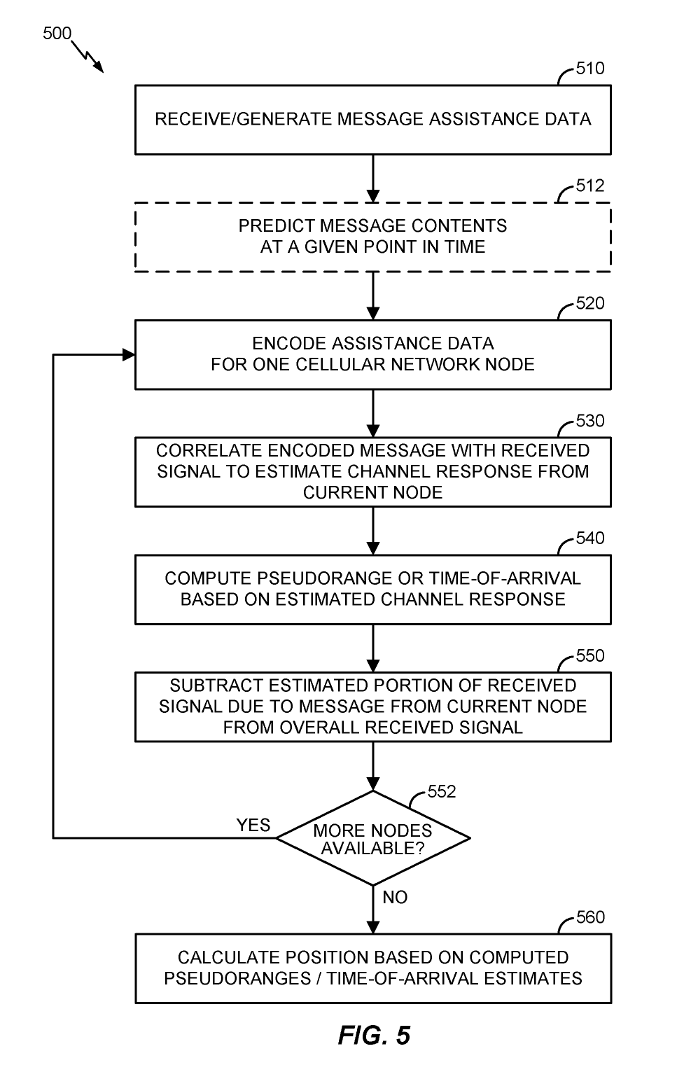

For example, according to various aspects, FIG. 5 illustrates an exemplary method 500 that a particular user device may perform to determine a position based on time-synchronized cellular data. In various embodiments, the user device may receive the above-described assistance data from a server at block 510. Alternatively, the user device may be configured to generate the assistance data at block 510 based on time-synchronized messages from cellular network nodes with which the user device has been in communication with. In the latter case, generating the assistance data locally may allow the user device to operate independently from the server, although fewer cellular network nodes may be measurable relative to using assistance data based on crowd-sourced messages that each node in the cellular network is configured to transmit at a synchronized time. Furthermore, in use cases where the assistance data comprises the most recent message information database, the user device may optionally predict the message contents associated with multiple neighboring nodes in an area around the user device at a given point in time at block 512. In any case, the time-synchronized message data for the multiple neighboring nodes may be available to the user device, which may encode the message data to obtain a local copy corresponding to the signal transmitted from a current node at block 520. Furthermore, at block 530, the user device may correlate the encoded message with an overall signal at one or more receive antennas on the user device. For example, the correlation operation may comprise estimating a channel response from one or more transmit antennas at the current node to the one or more receive antennas at the user device 300.

As such, based on the estimated channel response from the one or more transmit antennas at the current node to the one or more receive antennas at the user device, a pseudorange or time of arrival (TOA) estimate with respect to the time-synchronized message from the current node can be computed at block 540. In various embodiments, the estimated channel response can be used to estimate the signal received at the one or more receive antennas due to the message from the current node, which may be subtracted from the overall signal received at the corresponding receive antenna(s) at block 550. In various embodiments, a determination may be made at block 552 as to whether there is message information available from any additional nodes, in which case the operations described above with respect to blocks 520 through 550 may be repeated with respect to each node with available message information. In various embodiments, after the available message information from each node has been suitably processed, the user device may then calculate a position at block 560 based on the computed pseudoranges or TOA estimates.

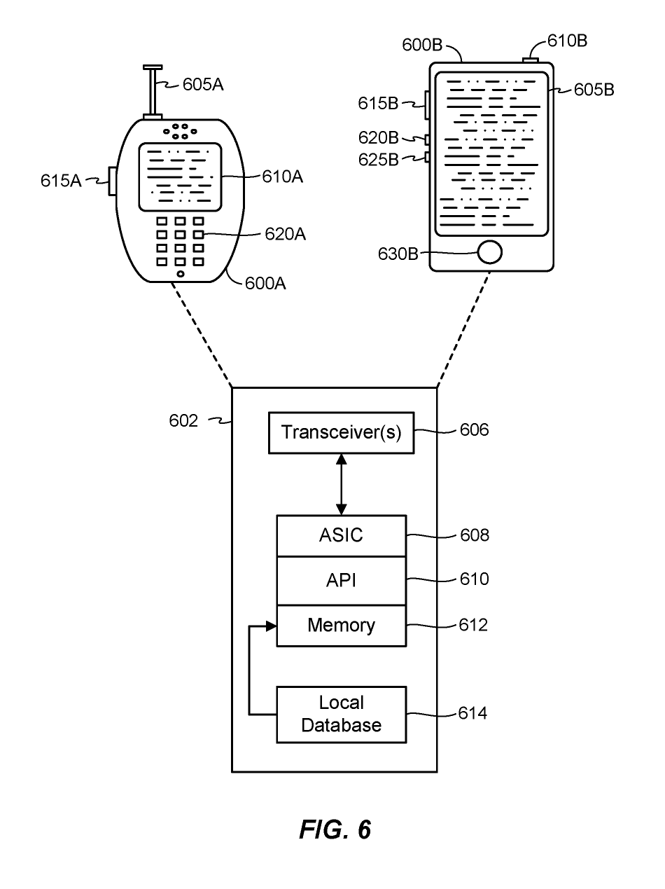

According to various aspects, FIG. 6 illustrates exemplary user devices 600A, 600B that may determine a position using time-synchronized cellular data as described in further detail above. Referring to FIG. 6, the first user device 600A is illustrated as a mobile telephone and the second user device 600B is illustrated as a touchscreen device (e.g., a smart phone, a tablet computer, etc.). As shown in FIG. 6, an external casing of the first user device 600A is configured with an antenna 605A, a display 610A, at least one button 615A (e.g., a power button, a volume control button, a PTT button, etc.) and a keypad 620A, among other components, as known in the art. Also, the second user device 600B has an external casing configured with a touchscreen display 605B, peripheral buttons 610B, 615B, 620B and 625B (e.g., a power control button, a volume or vibrate control button, an airplane mode toggle button, etc.), at least one front-panel button 630B (e.g., a Home button, etc.), among other components, as known in the art. Furthermore, although not explicitly shown in FIG. 6, the second user device 600B can include one or more external antennas and/or one or more integrated antennas that may be built into the external casing associated therewith, including but not limited to WLAN antennas, cellular antennas, satellite position system (SPS) antennas (e.g., global positioning system (GPS) antennas), and so on.

While the user devices 600A, 600B can have internal components potentially embodied according to different hardware configurations, a basic high-level configuration for internal hardware components is shown in FIG. 6 as a platform 602. In particular, according to various aspects, the platform 602 can receive and execute software applications, data, and/or commands transmitted from an access network that may ultimately come from a cellular network operator, the Internet, and/or other remote servers and networks (e.g., a server that crowd-sources contents associated with time-synchronized messages from various nodes in the cellular network and provides a database or a prediction relating to the messages to the user devices 600A, 600B). The platform 602 can also independently execute locally stored applications without interacting or communicating with an access network and/or support processing functions that relate to out-of-band communication with another user device located in sufficient proximity thereto. The platform 602 can include one or more transceivers 606 operably coupled to an application specific integrated circuit (ASIC) 608 or another suitable processor, microprocessor, logic circuit, and/or data processing device. The ASIC 608 and/or other suitable processor(s) may execute the application programming interface (API) 610 layer, which may interface with any suitable programs resident in the memory 612. According to various aspects, the memory 612 can comprise read-only memory (ROM), random-access memory (RAM), EEPROM, flash cards, and/or any other suitable memory common to computer platforms. The platform 602 also can include a local database 614 that can store applications not actively used in memory 612, as well as other suitable data. The local database 614 may typically be a flash memory cell, but can be any secondary storage device as known in the art, such as magnetic media, EEPROM, optical media, tape, soft or hard disk, or the like.

Accordingly, one embodiment disclosed herein can include a user device (e.g., user devices 600A, 600B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 608, memory 612, API 610 and local database 614 may all be used cooperatively to load, store and execute the various functions disclosed herein and thus the logic to perform these functions may be distributed over various elements. Alternatively, the functionality could be incorporated into one discrete component. Therefore, the features associated with the user devices 600A, 600B as shown in FIG. 6 are to be considered illustrative only, and the disclosure is not limited to the feature(s) or arrangement(s) illustrated therein.

The wireless communication between the user devices 600A, 600B, between the user devices 600A, 600B and an access network, and/or between the user devices 600A, 600B and other suitable network entities can be based on various different technologies, which may include, without limitation, CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed above and known in the art, voice transmission and/or data can be transmitted to the user devices 600A, 600B from an access network using various networks and configurations. Accordingly, the illustrations provided herein are not intended to limit the embodiments disclosed herein and are merely to aid in describing the various aspects and embodiments provided herein.

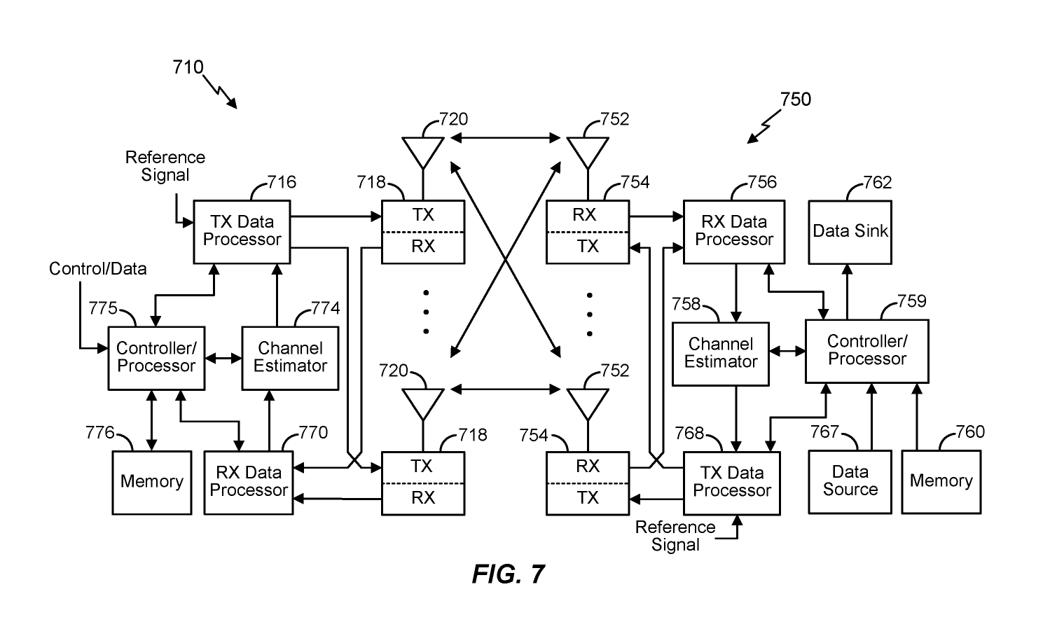

According to various aspects, FIG. 7 illustrates an exemplary user device 750 in direct or indirect communication with an exemplary network node 710 in a cellular communications network as described in further detail above. For example, in various embodiments, the network node 710 may comprise an eNB, MME, PDN Gateway, CSCF, and/or any other suitable node in the cellular communications network. On the downlink (DL), upper layer packets from a core network may be provided to a controller/processor 775 at the network node 710, wherein the controller/processor 775 may implement Layer-2 (L2) functionality. On the DL, the controller/processor 775 may provide header compression, ciphering, packet segmentation and reordering, multiplexing between logical and transport channels, and radio resource allocations to the user device 750 based on various priority metrics. The controller/processor 775 may also be responsible for implementing HARQ operations, retransmitting lost packets, and providing signaling to the user device 750.

According to various aspects, the network node may include a transmit (TX) data processor 716 configured to implement various signal processing functions for the Layer-1 (L1) layer (i.e., physical layer). The signal processing functions may include coding and interleaving to facilitate forward error correction (FEC) at the user device 750 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream may be spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the user device 750. Each spatial stream may then be provided to a different antenna 720 via a separate transmitter TX 718. Each transmitter TX 718 may modulate an RF carrier with a respective spatial stream for transmission.

At the user device 750, each receiver RX 754 may receive a signal through a respective antenna 752. Each receiver RX 754 may recover information modulated onto an RF carrier and provide the information to a receive (RX) data processor 756, which implements various L1 signal processing functions. The RX data processor 756 may perform spatial processing on the information to recover any spatial streams destined for the user device 750. If multiple spatial streams are destined for the user device 750, the multiple spatial streams may be combined at the RX data processor 756 into a single OFDM symbol stream. The RX data processor 756 may then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the network node 710. These soft decisions may be based on channel estimates computed by a channel estimator 758. The soft decisions are then decoded and deinterleaved to recover the data and control signals that were originally transmitted by the network node 710 on the physical channel The data and control signals are then provided to the controller/processor 759.

The controller/processor 759 may implement L2 functionality, wherein the controller/processor 759 can be associated with a memory 760 that stores program codes and data. The memory 760 may be referred to as a computer-readable medium. In the UL, the controller/processor 759 may provide demultiplexing between transport and logical channels, packet reassembly, deciphering, header decompression, and control signal processing to recover upper layer packets from the core network. The upper layer packets are then provided to a data sink 762, which generally represents all the protocol layers above L2. Various control signals may also be provided to the data sink 762 for L3 processing. The controller/processor 759 may also be responsible for error detection using an acknowledgement (ACK) and/or negative acknowledgement (NACK) protocol to support HARQ operations.

In the UL direction, a data source 767 in the user device 750 is used to provide upper layer packets to the controller/processor 759. The data source 767 represents all protocol layers above L2. Similar to the functionality described in connection with the DL transmission by the network node 710, the controller/processor 759 implements L2 functionality for the user plane and the control plane by providing header compression, ciphering, packet segmentation and reordering, and multiplexing between logical and transport channels based on radio resource allocations by the network node 710. The controller/processor 759 is also responsible for HARQ operations, retransmission of lost packets, and signaling to the network node 710. Channel estimates derived by the channel estimator 758 from a reference signal or feedback transmitted by the network node 710 may be used by the TX data processor 768 to select the appropriate coding and modulation schemes, and to facilitate spatial processing. The spatial streams generated by the TX data processor 768 are provided to different antenna 752 via separate transmitters TX 754. Each transmitter TX 754 modulates an RF carrier with a respective spatial stream for transmission.

The UL transmission is processed at the network node 710 in a manner similar to that described in connection with the receiver function at the user device 750. Each receiver RX 718 receives a signal through a respective antenna 720. Each receiver RX 718 recovers information modulated onto an RF carrier and provides the information to a RX data processor 770. The RX data processor 770 may implement L1 functionality. The controller/processor 775 implements L2 functionality and can be associated with a memory 776 that stores program codes and data. The memory 776 may be referred to as a computer-readable medium. In the UL, the control/processor 775 provides demultiplexing between transport and logical channels, packet reassembly, deciphering, header decompression, control signal processing to recover upper layer packets from the user device 750. Upper layer packets from the controller/processor 775 may be provided to the core network. The controller/processor 775 is also responsible for error detection using an ACK and/or NACK protocol to support HARQ operations.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method for use in wireless signal-based positioning, the method comprising, with a user device:
receiving a signal at one or more receive antennas on the user device, wherein the signal is received from a current node among multiple neighboring nodes in a wireless network;
encoding assistance data that includes predicted contents associated with messages that the multiple neighboring nodes are configured to transmit at a synchronized time to obtain the predicted contents associated with the message for the current node;
correlating the predicted contents associated with the message for the current node with the received signal to estimate a channel response from one or more transmit antennas at the current node to the one or more receive antennas on the user device; and
computing an estimated time of arrival from the current node based, at least in part, on the estimated channel response from one or more transmit antennas at the current node to the one or more receive antennas on the user device.

2. The method recited in claim 1, further comprising:
estimating, at the user device, a portion of an overall signal received at the one or more receive antennas attributable to the signal received from the current node;
subtracting, from the overall signal received at the one or more receive antennas, the estimated portion attributable to the signal received from the current node; and
repeating the encoding, correlating, and computing steps for each of the multiple neighboring nodes for which the message is available at the synchronized time.

3. The method recited in claim 2, further comprising computing a position associated with the user device based on the estimated time of arrival associated with the messages from the multiple neighboring nodes.

4. The method recited in claim 1, wherein the messages comprise information that the multiple neighboring nodes are configured to transmit at the synchronized time to enable communication with user devices in the wireless network.

5. The method recited in claim 1, wherein the predicted contents associated with the message comprise a system frame number at the synchronized time.

6. The method recited in claim 1, further comprising receiving the assistance data from a server, wherein the received assistance data comprises information associated with the messages for each node in the wireless network at the synchronized time.

7. The method recited in claim 1, further comprising generating the assistance data on the user device, wherein the generated assistance data comprises information associated with the messages for each node that the user device has been in communication with in the wireless network.

8. The method recited in claim 1, further comprising:
receiving the messages from the multiple neighboring nodes at the synchronized time; and
decoding one of the received messages from one of the multiple neighboring nodes that is a serving node for the user device.

9. The method recited in claim 8, further comprising transmitting the decoded message from the serving node to a server.

10. The method recited in claim 8, further comprising using the decoded message from the serving node to determine the predicted contents associated with the messages that the multiple neighboring nodes are configured to transmit at the synchronized time based on an assumption that the assistance data is the same for each of the multiple neighboring nodes.

11. An apparatus, comprising:
a transceiver comprising one or more receive antennas configured to receive a signal from a current node among multiple neighboring nodes in a wireless network; and
one or more processors configured to:
encode assistance data that includes predicted contents associated with messages that the multiple neighboring nodes are configured to transmit at a synchronized time to obtain the predicted contents associated with the message for the current node;
correlate the predicted contents associated with the message for the current node with the received signal to estimate a channel response from one or more transmit antennas at the current node to the one or more receive antennas; and
compute an estimated time of arrival from the current node based, at least in part, on the estimated channel response from one or more transmit antennas at the current node to the one or more receive antennas.

12. The apparatus recited in claim 11, wherein the one or more processors are further configured to:
estimate a portion of an overall signal received at the one or more receive antennas attributable to the signal received from the current node;
subtract, from the overall signal received at the one or more receive antennas, the estimated portion attributable to the signal received from the current node; and
iteratively encode, correlate, and compute the estimated time of arrival for each of the multiple neighboring nodes for which the message is available at a synchronized time.

13. The apparatus recited in claim 12, wherein the one or more processors are further configured to compute a position associated with the apparatus based on the estimated time of arrival associated with the messages from the multiple neighboring nodes.

14. The apparatus recited in claim 11, wherein the messages comprise information that the multiple neighboring nodes are configured to transmit at the synchronized time to enable communication with user devices in the wireless network.

15. The apparatus recited in claim 11, wherein the predicted contents associated with the message comprise a system frame number at the synchronized time.

16. The apparatus recited in claim 11, wherein the transceiver is further configured to receive the assistance data from a server, wherein the received assistance data comprises information associated with the messages for each node in the wireless network at the synchronized time.

17. The apparatus recited in claim 11, wherein the one or more processors are further configured to generate the assistance data based on information associated with the messages for each node that the apparatus has been in communication with in the wireless network.

18. The apparatus recited in claim 11, wherein the transceiver is further configured to:
receive the messages from the multiple neighboring nodes; and
transmit the message from one of the multiple neighboring nodes that is a serving node for the apparatus to a server.

19. The apparatus recited in claim 11, wherein the one or more processors are further configured to:
decode one of the messages received from one of the multiple neighboring nodes that is a serving node for the apparatus; and
use the decoded message from the serving node to determine the predicted contents associated with the messages that the multiple neighboring nodes are configured to transmit at the synchronized time based on an assumption that the assistance data is the same for each of the multiple neighboring nodes.

20. An apparatus, comprising:
means for receiving a signal from a current node among multiple neighboring nodes in a wireless network;
means for encoding assistance data that includes predicted contents associated with messages that the multiple neighboring nodes are configured to transmit at a synchronized time to obtain the predicted contents associated with the message for the current node;
means for correlating the predicted contents associated with the message for the current node with the received signal to estimate a channel response from one or more transmit antennas at the current node to the means for receiving; and
means for computing an estimated time of arrival from the current node based, at least in part, on the estimated channel response from one or more transmit antennas at the current node to the means for receiving.
